(19) United States
(12) Patent Application Publication
(10) Pub. No.: US 2022/0114612 A1
(43) Pub. Date: Apr. 14, 2022

(54) SYSTEMS AND METHODS FOR GENERATING AN ADVERTISING-ELASTICITY MODEL USING NATURAL-LANGUAGE SEARCH

(71) Applicant: KEEN DECISION SYSTEMS, INC., Durham, NC (US)

(72) Inventors: John BUSBICE, Durham, NC (US); Joshua LUCAS, Raleigh, NC (US); Wilfred RAYMOND, Chapel Hill, NC (US)

(21) Appl. No.: 17/491,933

(22) Filed: Oct. 1, 2021

Related U.S. Application Data
(63) Continuation of application No. PCT/US21/51889, filed on Sep. 24, 2021.
(60) Provisional application No. 63/090,361, filed on Oct. 12, 2020.

(51) Int. Cl. G06Q 30/02; G06F 16/242

(52) U.S. Cl. CPC G06Q 30/0242; G06F 16/243

(57) ABSTRACT

Systems and methods for generating an advertising-elasticity model using natural-language search are disclosed. The systems and methods generate a mapping function that generates a reduced set of user topics based on user-supplied tags, and uses the user topics to derive an estimate of advertising elasticity for a given advertising activity.

### CROSS-REFERENCE TO RELATED APPLICATIONS

This application is a continuation application of PCT Application No. PCT/US21/51889 filed on Sep. 24, 2021 which claims priority to U.S. Provisional Patent Application No. 63/090,361 filed on Oct. 12, 2020, by Keen Decision Systems, Inc., titled “SYSTEMS AND METHODS FOR GENERATING AN ADVERTISING-ELASTICITY MODEL USING NATURAL-LANGUAGE SEARCH,” the entire contents of all of which are incorporated by reference herein.

### TECHNICAL FIELD

The present invention relates to systems and methods for generating an advertising-elasticity model using natural-language search. More specifically, the present invention relates to generating a mapping function that maps user-supplied search terms to existing normative data to provide estimates of advertising-elasticity based on the user-supplied search terms.

### BACKGROUND

In marketing, there are numerous different ways to invest marketing dollars, and there are continuous, rapidly evolving innovations in the types of marketing media available for advertisers and advertising campaigns. As these new innovations in the types of marketing media evolve, it can be difficult to predict the effectiveness of these new innovations because of a lack of prior data relating to their effectiveness.

The concept of advertising elasticity refers to a measure of the effectiveness of a particular advertising investment. Estimates of advertising elasticity for a proposed advertising tactic may be determined using a Bayesian statistical model that includes prior estimates of advertising elasticity. The advertising elasticity of a proposed course of action may be calculated as a probability distribution based on prior estimates of advertising elasticity. A problem with this approach, however, is that the prior estimates of advertising elasticity do not necessarily take into account the differences between the future marketing tactics and the known marketing tactic from which current estimates of advertising elasticity are generated.

Accordingly, a need exists for a way to generate a prior estimate of advertising elasticity for a given unknown tactic that takes into account what is known about current tactics.

### SUMMARY

The presently disclosed subject matter solves the above problems by providing systems and methods for generating an advertising-elasticity model using natural-language search.

The systems and methods described herein allow a user to describe advertising activities using natural-language terms, and then determines and provides a probabilistic assignment of the user's advertising activity to existing normative data relating to advertising elasticity. Based on this determined probabilistic assignment of the user's advertising activity, the systems and methods described herein provide estimates of advertising elasticity to the user that represent overall projected benefit of the advertising activity.

A method of determining an estimate of advertising elasticity using natural-language search is disclosed. The method includes receiving user-supplied natural-language search terms for querying a normative database. The normative database includes normative data. The normative data includes a mean value, a standard deviation value, and a plurality of existing tags for one or more advertising variables stored in the normative database. The method further includes deriving a mapping function based on the normative data by analyzing the plurality of existing tags in the normative data to determine a function that maps the plurality of existing tags to a set of normative topics associated with the normative data such that the set of normative topics represents variation in the plurality of existing tags across the normative database. The method further includes applying the derived mapping function to the user-supplied natural-language search terms. The user-supplied natural-language search terms are provided as inputs to the derived mapping function. The method further includes generating a set of mapped user topics from the user-supplied natural-language search terms based on the derived mapping function. The method further includes determining a similarity value for at least one of the one or more advertising variables using a similarity function. The similarity value for the advertising variable represents a similarity between the set of mapped user topics and the set of normative topics relative to the advertising variable. The method further includes deriving an estimate of advertising elasticity for the user-supplied natural-language search terms based on the determined similarity value, the mean value, and the standard deviation value for the advertising variable.

In one embodiment of the method disclosed herein, the user-supplied natural-language search terms represent an advertising activity.

In one embodiment of the method disclosed herein, the user-supplied natural-language search terms are received over a network.

In one embodiment of the method disclosed herein, the user-supplied natural-language search terms are supplied by a user via a graphical user interface.

In one embodiment of the method disclosed herein, the normative database comprises a relational database.

In one embodiment of the method disclosed herein, the mapping function is derived by analyzing tags in the normative data using singular value decomposition.

In one embodiment of the method disclosed herein, the mapping function is derived by analyzing tags in the normative data using non-negative matrix factorization.

In one embodiment of the method disclosed herein, the mapping function is derived by analyzing tags in the normative data using latent Dirichlet analysis.

In one embodiment of the method disclosed herein, the set of mapped user topics corresponds to the set of normative topics associated with the normative data. In other embodiments, the set of mapped user topics does not match the set of normative topics associated with the normative data.

In one embodiment of the method disclosed herein, the similarity function takes as inputs the set of mapped user topics and the set of normative topics and returns as an output the similarity value, the similarity value being such that it measures the similarity between the set of mapped user topics and the set of normative topics.

In one embodiment of the method disclosed herein, the similarity function performs a cosine similarity analysis on the inputs.

In one embodiment of the method disclosed herein, the similarity function performs an inverse Euclidean distance analysis on the inputs.

In one embodiment of the method disclosed herein, the estimate of advertising elasticity is derived using the mean value and the standard deviation value for the advertising variable in the normative database, with the mean value and the standard deviation value for the advertising variable being weighted according to the determined similarity value for the advertising variable.

In one embodiment of the method disclosed herein, the estimate of advertising elasticity is calculated as a weighted average over a plurality of advertising variables in the normative database using the mean value and the standard deviation value for each of the plurality of advertising variables.

In one embodiment of the method disclosed herein, the estimate of advertising elasticity is calculated by aggregating the plurality of mean values and standard deviation values.

In one embodiment of the method disclosed herein, the derived estimate of advertising elasticity represents an advertising elasticity of an advertising activity based on the user-supplied natural-language search terms.

### BRIEF DESCRIPTION OF THE DRAWINGS

FIG. 1 depicts an exemplary configuration of a normative database.

FIG. 2 depicts an exemplary data flow for a method of generating an advertising-elasticity model using natural-language search.

FIG. 3 depicts an example of how the search-engine process of FIG. 2 maps normative data to normative topics.

FIG. 4A depicts an example of how the meta-analysis process of FIG. 2 uses the reduced set of mapped user topics generated from the search-engine process shown in FIG. 3 to generate an estimate of advertising elasticity based on the user topics.

FIG. 4B depicts an example of how the meta-analysis process of FIG. 2 uses the reduced set of mapped user topics generated from the search-engine process shown in FIG. 3 to generate an estimate of advertising elasticity based on the user topics.

FIG. 5A depicts an exemplary process flow for a method of determining an estimate of advertising elasticity using natural-language search.

FIG. 5B depicts an exemplary process flow for a method of determining an estimate of advertising elasticity using natural-language search.

FIG. 6 depicts a block diagram illustrating one embodiment of a computing device that implements the methods and systems for generating an advertising-elasticity model using natural-language search described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. Multiple appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Disclosed herein are systems and methods for generating an advertising-elasticity model using natural-language search. The disclosed systems and methods include a normative database that stores normative data relating to advertising elasticity that can be used for decision making around advertising spend. The disclosed systems and methods use the normative database to provide a user with an estimate of advertising elasticity tailored to the user's description of an advertising activity or advertising campaign based on a meta-analysis of the normative database.

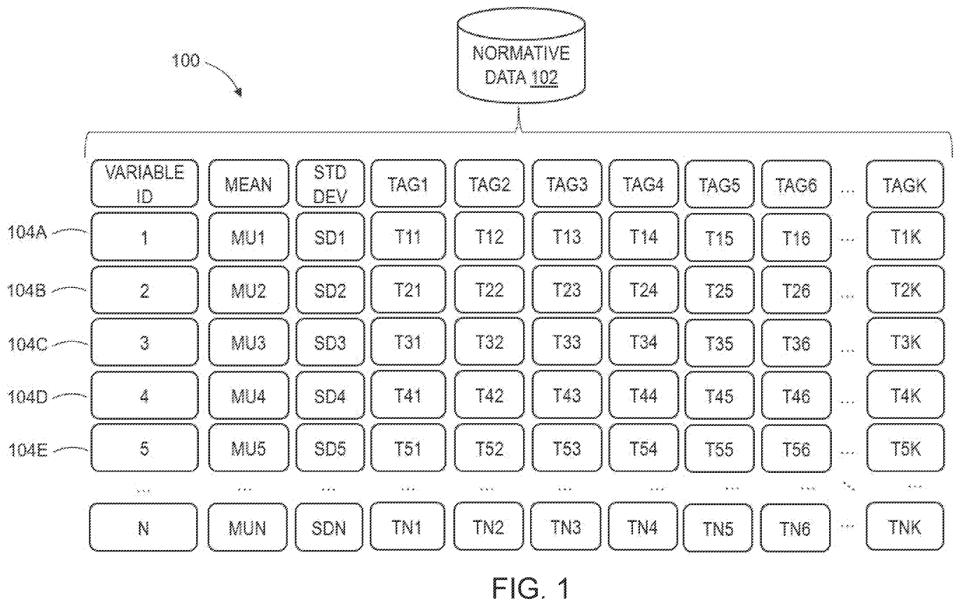

FIG. 1 depicts an exemplary configuration of a normative database.

Referring to FIG. 1, the exemplary normative database 102 stores a plurality of records 104A-104E, which include estimates of advertising elasticity as well as additional data relating to the estimates of advertising elasticity. Each record or row 104 of the database 102 represents a probabilistic estimate for advertising elasticity, described by the mean and standard deviation, for a particular Variable. Each record or row 104 also contains text tag data that relates to the Variable. Each Variable (i.e., record or row) may be any particular aspect of an advertising or marketing tactic, such as, for example, “Social Video,” “YouTube,” “Network Television,” or “Unbranded Search.”

Each row 104 in the exemplary normative database 102 includes a “Variable ID” field. The Variable ID is a unique key for the row. Each row 104 represents an estimate of advertising elasticity for the Variable represented by the row from any number of sources, which include but are not limited to models that have been input by users, generated by users, or generated as a part of academic literature.

Each row 104 in the exemplary normative database includes a “Mean” field. The Mean is an estimate of the advertising elasticity for the particular Variable represented by that row. In other words, for a row for a “Social Video” Variable, the Mean value represents a point estimate of the advertising elasticity for “Social Video” based on a previous estimate of advertising elasticity for a social video tactic.

Each row 104 in the exemplary normative database 102 includes a “Std Dev” field, which refers to the standard deviation around the mean (i.e., the “Mean” field) of the advertising elasticity.

The exemplary normative database 102 comprises a number of tags, which provide additional datapoints for each Variable in the database. Each row 104 in the exemplary normative database 102 includes one or more “Tag” fields, which may be represented, for example, as Tag₁ . . . Tagₖ. The “Tag₁” through “Tagₖ” fields contain each of the tags that are included in the normative database. The tags describe or otherwise relate to various particular aspects of the Variable represented by a particular row. The tags may be words, names, phrases, or other descriptors that describe the particular advertising activity being represented by the row. The tags may be text descriptors, for example: “Trade,” “TV,” “Online,” “Search,” “Paid,” “YouTube,” “Walmart,” “Programmatic,” or the like. These tags may be curated collaboratively between curators for the system and users of the system. In addition to the text descriptor, each tag within each record may be assigned an indicator, for example, where a 1 (or TRUE) indicates that the tag is present in the user's description, and a 0 (or FALSE) indicates otherwise (e.g., that the tag is not present in the user's description).

In addition, the exemplary normative database 102 may comprise one or more metrics for tracking data related to Variables. The metrics may include trackable data, such as likes, views, impressions, clicks, spend, or the like.

The normative database 102 may be populated with data in various ways. One way for data to be entered into the normative database is where a user enters the data (e.g., text data) into the normative database via a graphical user interface. For example, the user may enter a name for a variable to be used in the analysis (e.g., “Social Video”), a text description of the variable (e.g., “Boosted video ads shared on social media sites”), and any metrics associated with the variable (e.g., “Likes,” “Impressions,” or “Spend”).

To generate tags from the user-input data, the system generates keywords based on the user's input for the Variable. For example, the system may parse the text of the name of the Variable, the description of the Variable, and the metrics associated with the Variable. This text parsing generates one or more tags that represent the parsed values. The generated tags may then be further enhanced with one or more second-level meta-tags. At this point, the user may be presented with an option to add, modify, or delete any of the one or more tags associated with the variable that were generated by the system.

Another way for data to be entered into the normative database 102 is through data curators. Existing data may be entered into the normative database 102 manually by admin users of the system. These may be primary tags or second-level meta-tags. The existing data may be entered manually, or it may be imported from another electronic file, such as a data table, a .csv file, an Excel® spreadsheet file, another database, or the like. The existing data may come from academic journals that publish studies relating to advertising elasticity, such as an elasticity table. For example, an academic journal may publish a study along with the corresponding research data used for the study. The research data may be published in the form of a table or a meta-analysis database. Such research data may then be imported into the normative database 102 to provide additional data points to be used.

The curation process for adding existing data to the normative database 102 is an ongoing process that may occur each time new data is released or gathered.

The normative database 102 may be implemented using any known database structure, such as a relational database, a SQL database, or the like. The normative database 102 may be accessed through a graphical user interface and may be queried using known database queries to access the data stored in the database. The normative database may be implemented as one or more servers, either located on-premises or in the cloud as one or more logical servers. The servers may be run with one or more processors that perform the operations as described herein.

The exemplary normative database 102 may be used to provide users with estimates of advertising elasticity for a given advertising activity. For example, assume a user wants to determine the advertising elasticity of a proposed new advertising campaign using video that will be deployed over numerous social media channels. In such an example, the user may query the normative database using the tags “video” and “social media.” The normative database determines an advertising elasticity for that particular query. This is accomplished by calculating a probability distribution of the advertising elasticity based on the existing records in the normative database that include the user-provided tags. The probability distribution may be estimated by using the average and standard deviation or percentiles of the mean elasticity, or by using regression analysis with user-provided tags as covariates. Thus, the normative database 102 returns the calculated mean and standard deviation values that represent the expected advertising elasticity, which is determined based on the records 104 in the normative database that include the tags “video” and “social media.”

One problem with this approach, however, is that the tags used by the user need to match the tags in the normative database to calculate the most accurate estimate of advertising elasticity. In other words, referring to the example above, if a record in the normative database uses the tag “social” rather than “social media,” then that record either may not be included or may be included but incorrectly weighted in the calculated advertising elasticity. Thus, because the user may not have knowledge of the existing tags that are in use in the normative database, and if there is no standardized tag system, then the issue is further exaggerated as many records in the normative database may include slightly different tags to refer to essentially the same concept. Additionally, as advertising trends evolve, there may be new concepts or advertising avenues that are not accurately captured or represented by the existing tag set. Thus, when a user searches using terms related to this new technology or advertising avenue, those keyword searches may not align with any existing tags, thus resulting in incomplete or incorrectly weighted calculations.

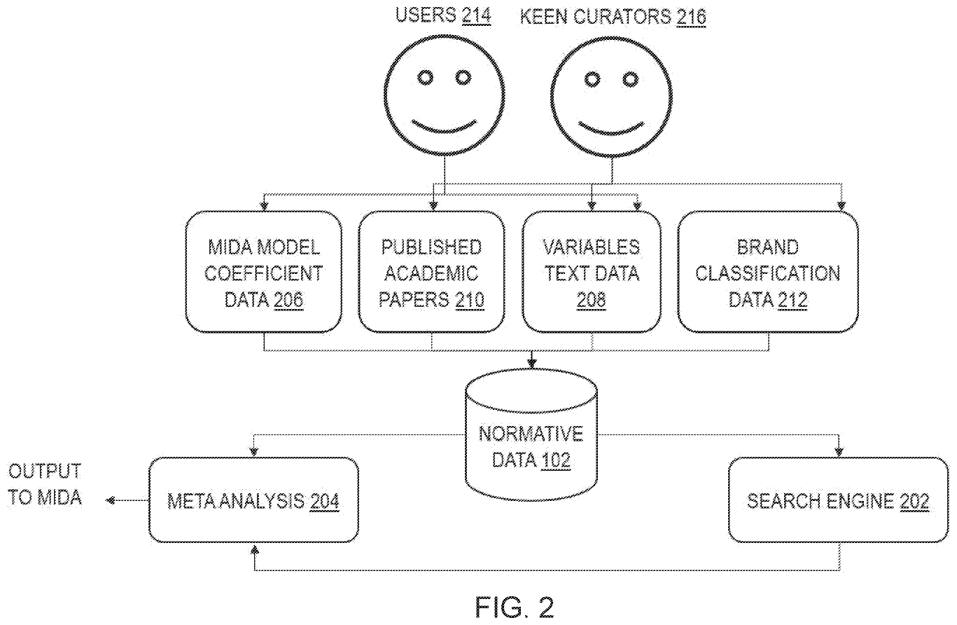

FIG. 2 depicts an exemplary data flow for a method of generating an advertising-elasticity model using natural-language search.

Referring to FIG. 2, the systems and methods described herein include a normative database, such as the exemplary normative database 102 described in the context of FIG. 1. The normative database 102 is communicatively coupled to a search-engine process 202 and a meta-analysis process 204 such that each of the meta-analysis 204 and the search engine 202 can send data to (e.g., store data in) and receive data from (i.e., query for data) the normative database 102. The search-engine process 202 and the meta-analysis process 204 are communicatively coupled to one another such that data from the search-engine process 202 is fed into the meta-analysis process 204. The search-engine process 202 and the meta-analysis process 204 may be run on the same server as the normative database 102, or they may be run on one or more separate computing devices that communicate with the normative database 102 (e.g., over an Internet or other type of connection).

As shown in FIG. 2, the normative database 102 may be populated using model coefficient data 206, variables text data 208, published academic papers 210, and brand classification data 212. The model coefficient data 206 is the mean and standard deviation of advertising elasticity. The variables text data 208 includes user-input or curated tags that describe advertising activities or other data of interest. The academic papers 210 may include published advertising elasticity data, as described above in the context of FIG. 1. The brand classification data 212 is brand-level tags that describe any number of non-specific identifying information about the brand, product or the manner of distributing, selling or purchasing the product. All of this data may be input into the normative database 102 by users 214 of the database system or by curators 216 associated with the database system using a graphical user interface that provides read, write, and/or modify access to the data records in the database. The users 214 may provide topics associated with variables and run the models. The curators 216 may review, clean, and add data from academic journals and classify brands, and tune the algorithms on a periodic basis.

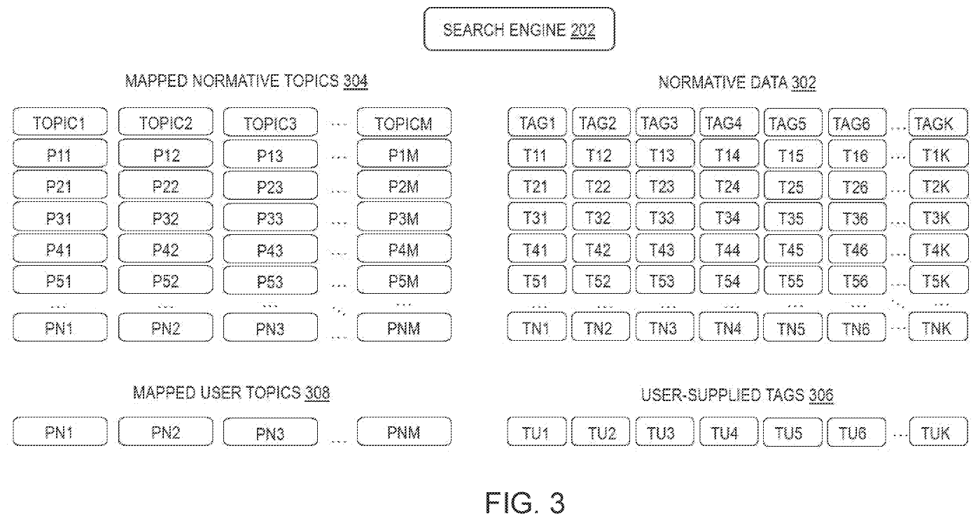

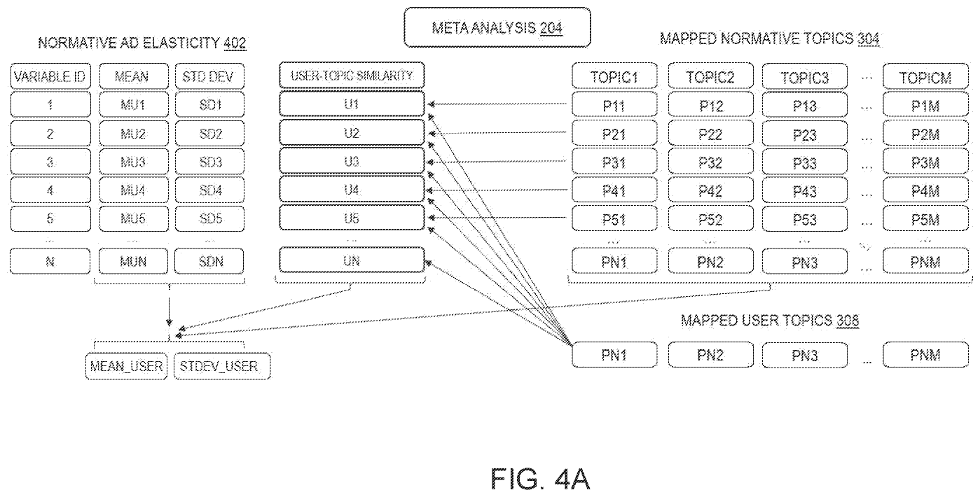

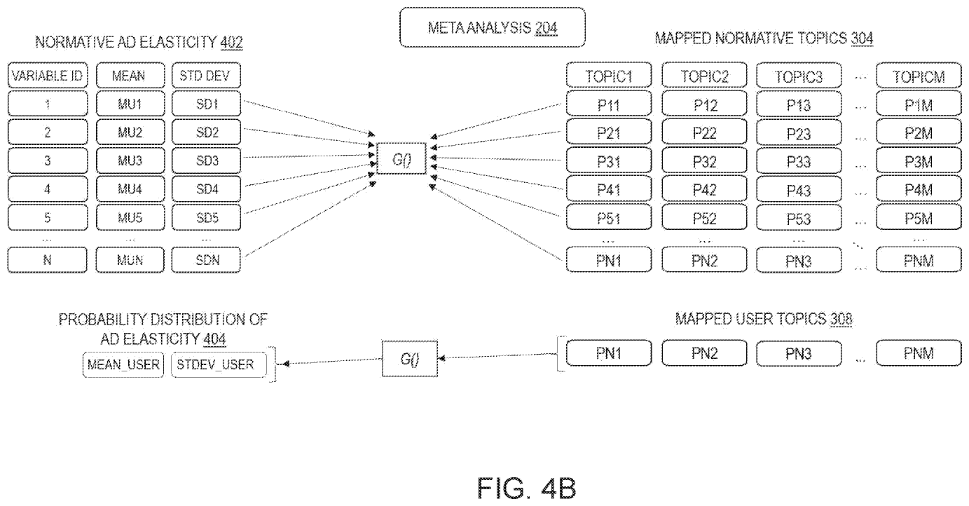

One innovative aspect of the systems and methods for generating an advertising-elasticity model using natural-language search described herein is that they provide a structure for interaction between the normative database 102, the search-engine process 202, and the meta-analysis process 204 such that a user can use a natural-language search on data stored in the normative database, and the meta-analysis will return a meta-analysis model for advertising elasticity based on the natural-language search terms. To accomplish this innovative aspect, the systems and methods described herein provide or generate additional data that may be associated with each record in the normative database. This additional data includes “Topic” data and “Similarity” data, as shown, for example, in FIG. 3 and FIG. 4A. Topics are numerical values that are associated with a group or combination of tags. For example, a particular topic number may correspond to a “social media” group, which is a group that includes tags for “Facebook,” “Twitter,” “Instagram,” and “Snapchat.” Similarity is a numerical value used by the systems and methods described herein that represents the strength of the relationship between the variable represented by the particular row and the particular set of user-supplied terms.

The search-engine process 202 shown in FIG. 2 receives natural-language text input (e.g., natural-language search terms) from a user 214 (e.g., via a graphical user interface) and queries the tag fields of the normative database 102 and generates, based on the queried tags, a reduced list of topics to be used in the meta-analysis process 204. The search-engine process 202 provides the reduced list of topics to the meta-analysis process.

In some embodiments, a library of synonyms may be used to reconcile terms and commons misspellings as received as part of the user-supplied natural-language text input to a common set of tags. This helps the translation of user-supplied information to useful data capable of being interpreted by the system. The synonyms used in the library of synonyms are specific to advertising and are not necessarily general synonyms of the English language. For example, the user-supplied term “amazon” maps to the tag “amazon,” which indicates the online retailer Amazon.com®. Additionally, the library of synonyms may include “ams” and “amg” as synonyms for “amazon” such that a user-supplied search for “ams” or “amg” will likewise map to the tag “amazon.” The library of synonyms may be used during training to map training data to tags, and it may also be used at run time to map the user-supplied natural-language text input to tags.

In some embodiments, a mapping between the tags and a set of meta-tags that logically maps tags about media to the communication modality or the psychological appeal of the media is used. As described above, each tag may include meta-tags, which provide information about the tag. The mapping between the tags and the set of meta-tags allows for connections between the tags, when creating the topics, that may not necessarily be made based on the natural language.

Advantages of adapting the meta-analysis process to take as input the output from the search-engine process as described herein includes the ability of the search-engine process to adapt dynamically as new cases (e.g., records) are added to the normative database, and the ability to semantically connect cases that might otherwise be treated as separate in a traditional meta-analysis and generalize to variables not specifically defined in the database.

FIG. 3 depicts an example of how the search-engine process of FIG. 2 maps normative data to normative topics.

The search-engine process 202 shown in FIG. 3 maps tags to topics. As explained above, the systems and methods described herein provide additional Topic data that is associated with the data stored in the normative database. Thus, as shown in FIG. 3, the data in the normative database may further be associated with “Topic” fields, which may be represented as Topic₁ . . . Topicₘ, for each row or record. The Topic fields store a value for each row that provides a numerical value for an association between a particular Topic and a Variable. The function M( ) is a mapping function that is derived from the normative database and that, when applied, results in a reduced set of Topics that is generated from the set of Tags. The mapping function M( ) may be derived, for example, by finding the weighted linear combination of existing tags in the normative database that best accounts for variation across the set of tags. The set of tags provides semantic meaning about the variables, but also includes idiosyncratic information related to a particular user's description of a variable. By finding the weighted linear combination of tags, the mapping function M( ) is able to derive the semantic meaning from the use of particular tags based on their relationship to other tags in the database. By finding a reduced set of topics that are combinations of tags, this method is able to separate the meaning from the idiosyncratic noise. Methods such as singular value decomposition, non-negative matrix factorization, latent Dirichlet analysis, other dimension reduction methods, or clustering methods may be used to derive the mapping function M( ).

Thus, when an existing Tag (i.e., a Tag that already exists in the normative database) is input into the derived mapping function M( ), the mapping function M( ) returns a set of existing Topics (i.e., Topics that already exist that are associated with the normative database), as shown by the following equation:

$$MAPPED\_NORMATIVE \_TOPICS = M ( Tag )$$

Similarly, when a user-supplied tag is input into the derived mapping function M( ), the mapping function M( ) returns a set of mapped user topics, as shown by the following equation:

$$MAPPED\_USER \_TOPICS = M ( USER\_TAGS )$$

For clarity, the mapping function M( ) that maps user-supplied tags to mapped user topics may be the same mapping function M( ) that is derived from the normative data in the normative database.

Whenever new data is added to the normative database, that new data may be retrospectively analyzed to update the existing topics as well as to generate additional new topics as necessary, as well as to regenerate a new or updated mapping function M( ). In this way, the search-engine process adapts dynamically as new cases (e.g., records) are added to the normative database.

A function G( ) is used to generate estimates of advertising elasticity. In one embodiment, as shown in FIG. 4A, the function G( ) is a similarity function G( ) that is used to generate estimates of advertising elasticity. In another embodiment, as shown in FIG. 4B, the function G( ) is a regression model that is used to generate estimates of advertising elasticity.

FIG. 4A depicts an example of how the meta-analysis process of FIG. 2 uses the reduced set of mapped user topics generated from the search-engine process shown in FIG. 3 to generate an estimate of advertising elasticity based on the user topics.

Referring to FIG. 4A, the mapped normative topics 304 shown on the right side of FIG. 4A are the mapped normative topics that were derived using the mapping function M( ) described in the context of FIG. 3. Similarly, the mapped user topics 308 shown on the right side of FIG. 4 are the mapped user topics that were returned using the mapping function M( ) described in the context of FIG. 3.

The similarity function G( ) is a function that measures the similarity between the USER_TOPIC and the NORMATIVE_TOPIC using methods such as cosine similarity or inverse Euclidean distance. The similarity function G( ) is shown by the following equation:

$$USER\_TOPIC \_SIMILARITY = G ( USER\_TOPIC , NORMATIVE TOPIC )$$

The estimation function F( ) is a function that combines all the information from the normative database with the USER_TOPIC_SIMILARITY to derive the prior estimates of MEAN_USER, STDEV_USER. These derived prior estimates represent the advertising elasticity generated based on the user-supplied tags. The estimation function F( ) is shown by the following equation:

$$MEAN\_USER , STD\_USER = F ( MEAN , STDEV , USER\_SIMILARITY , USER TOPICS )$$

FIG. 4B depicts an example of how the meta-analysis process of FIG. 2 uses the reduced set of mapped user topics generated from the search-engine process shown in FIG. 3 to generate an estimate of advertising elasticity based on the user topics.

Referring to FIG. 4B, a regression model is used to estimate the function G( ) instead of using the similarity function G( ) to generate the estimate of advertising elasticity based on the user topics.

The function G( ) is estimated. The process of estimating G( ) includes performing quantile regression at given percentiles to generate linear mapping function between the mapped normative topics 304 and values of mean and standard deviation (or coefficient of variation) that represent the normative ad elasticity 402. An array of quantile values and corresponding percentiles conditional on the mapped normative topics 304 is generated. A full probability distribution of ad elasticity is estimated using the metalog distribution. The estimated function G( ) is then used at runtime to generate the probability of advertising elasticity 404 based on the mapped user topics 308.

A regression model is used to infer the distribution of the elasticity conditional on the array of topic scores as independent variables. The distribution is characterized by the mean and coefficient of variation. The coefficient of variation is calculated as the standard deviation divided by the mean. This estimation for both metrics is performed using quantile regression, which yields a percentile for each of the mean and the coefficient of variation. Therefore, the measure of the distribution of elasticity are themselves characterized by a distribution based on the quantiles corresponding to the percentiles from the quantile regression.

The full probability distribution of the mean and coefficient of variation is estimated using the metalog distribution, based on the relationship between the percentiles and quantiles which are conditional on the natural language tags.

New distributions are predicted based on any new set of natural language tags, and a prior mean and variance of the elasticity is returned for use by the system.

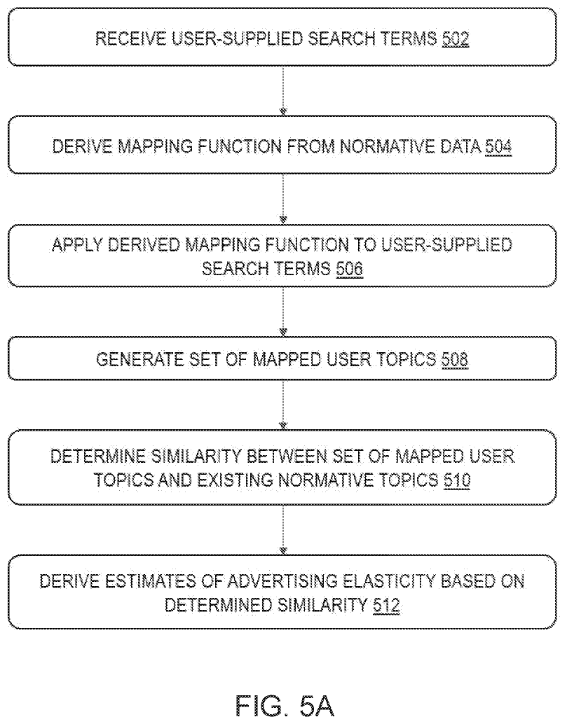

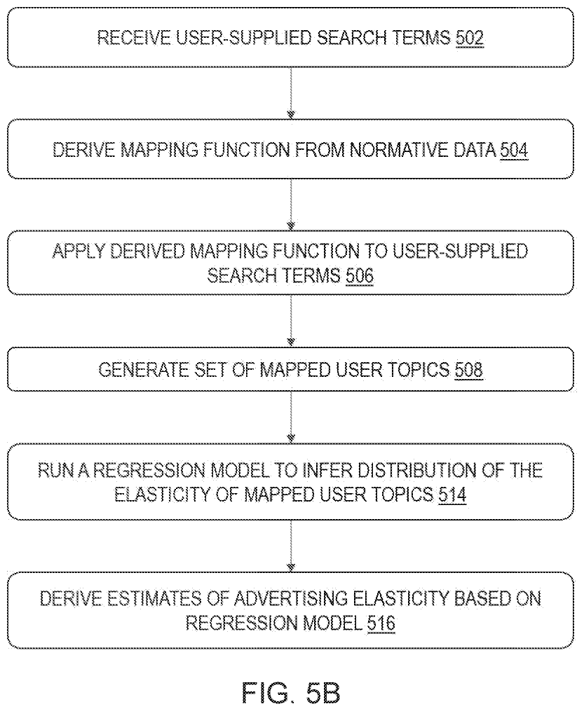

FIG. 5A depicts an exemplary process flow for a method of determining an estimate of advertising elasticity using natural-language search.

Referring to FIG. 5A, at step 502, the system receives user-supplied search terms. As explained above, the user-supplied search terms comprise natural-language search terms for querying a normative database. The normative database includes normative data, which includes mean values, standard deviation values, and existing tags for advertising variables stored in the normative database. The natural-language search terms describe one or more aspects of an advertising activity for which a user seeks to find an estimate of advertising elasticity. The combination of user-supplied search terms may or may not correspond to the exact combination of tags that exist in the normative database. The user supplying the user-supplied search terms need not know what tags exist in the normative database or what topics are associated with the normative database when selecting the user-supplied search terms.

In some embodiments, synonyms of the user-supplied natural-language search terms are further provided as inputs to the derived mapping function. The synonyms of the user-supplied natural language search terms are determined using a synonym library.

At step 504, the system derives a mapping function from the normative data. The normative data refers to existing data stored in the normative database. As explained in the context of FIG. 3, the derived mapping function is a function that takes text as input and returns a set of topics as an output. The mapping function is derived by analyzing the existing tags in the normative data using, for example, singular value decomposition, non-negative matrix factorization, or latent Dirichlet analysis, to determine a function that most highly correlates the existing tags in the normative data to normative topics associated with the normative data. The normative topics represent the variation in the existing tags across the normative database. Thus, as derived, the mapping function will, given a particular text input, return a set of topics that are best represented in a way that is consistent with the normative topics.

At step 506, the system applies the derived mapping function to the user-supplied search terms. The derived mapping function is provided with the user-supplied search terms as the input, and those user-supplied search terms are then mapped to a reduced set of existing topics.

Put another way, the mapping function is derived using known combinations of tags to map to topics. Once the mapping function has been derived using known combinations and topics, it can then be used to map other combinations of tags to topics. Thus, the derived mapping function is able to handle any user-supplied combination of search terms because the combination need not be known ahead of time for the mapping function to work.

At step 508, the system generates the set of mapped user topics from the user-supplied search terms. This generated set of mapped user topics is the output from the derived mapping function with the user-supplied search terms as the input. As with the user-supplied search terms, the mapped user topics may or may not match the normative topics associated with the normative data.

In some embodiments, generating the set of mapped user topics from the user-supplied natural-language search terms is further based on a mapping between the existing tags and a set of meta-tags. In an embodiment, the mapping between the existing tags and the set of meta-tags provides a mapping from a type of media to a communication modality. In an embodiment, the mapping between the existing tags and the set of meta-tags provides a mapping from a type of media to a psychological appeal of the type of media.

At step 510, the system determines the similarity between the set of mapped user topics and the existing normative topics. The existing normative topics are the topics that are associated with the normative database. The similarity between the set of mapped user topics and the normative topics is determined for each of the advertising variables using a similarity function, which is a function that takes as input the mapped user topics and the normative topics and performs a cosine similarity analysis or an inverse Euclidean distance analysis on the inputs to return a similarity value that measures the similarity between the mapped user topics and the normative topics for each advertising variable. The similarity value for each advertising variable represents a similarity between the set of mapped user topics and the normative topics relative to the advertising variable.

At step 512, the system derives estimates of advertising elasticity based on the determined similarity. More specifically, the system derives a mean and standard deviation of the advertising elasticity for a user-supplied variable based on a function of (a) the determined similarity between the user-supplied variable and each record in the database, and (b) the mean and standard deviation of the estimate of advertising elasticity for each record. As mentioned, each record represents an advertising tactic in the normative database, and the user-supplied advertising tactic may be associated with one or more user-supplied search terms. The mean and standard deviation may be derived using various functions to calculate the values. One example of such function is a weighted average. In such an example, the mean for the user-supplied variable may be derived using the mean values for all records in the normative database in a calculation of the weighted-average elasticity, weighted according to the measure of topic similarity (e.g., the value for the variable shown in the User-topic Similarity field shown in FIG. 4). The weighted average represents the mean advertising elasticity of a tactic based on the user-supplied search terms. Similarly, in this example, the standard deviation may be derived from the square root of the weighted average of the square of the differences between the mean advertising elasticity as recorded for each tactic in the normative database and the calculated mean elasticity per above, plus the weighted average of the variance of each elasticity recorded for each advertising tactic in the normative database. Other functions may be used as well, depending, for example, on the particular type of weighting desired, the relationship sought between the topics, and the like.

FIG. 5B depicts an exemplary process flow for a method of determining an estimate of advertising elasticity using natural-language search.

Referring to FIG. 5B, steps 502 through 508 are the same as described in the context of FIG. 5A.

In various embodiments, at step 514, the system runs a regression model to infer a distribution of elasticity of the set of mapped user topics. In some embodiments, the running the regression model to infer a distribution of elasticity of the set of mapped user topics includes using records of the mean advertising elasticity and the standard deviation about that mean to calculate the coefficient of variation for each record as the standard deviation divided by the mean. The system runs a series of quantile regression models with different percentile parameters to infer the quantile of the metric of interest based on mapped user topics. As result of running the regression model, the system estimates an array of quantiles associated with percentiles conditional on mapped user topics. The full distribution of the mean and coefficient of variation is calculated using the metalog distribution based on the quantiles and percentiles from the regression.

In various embodiments, at step 516, the system derives estimates of advertising elasticity based on the regression model. The system predicts new distributions based on any new set of natural language tags, and a prior mean and variance of the elasticity is derived.

The methods described herein, including the method described in the context of FIGS. 5A and 5B, may be performed by a computer system comprising one or more processors for executing the methods described herein. The computer system may further comprise memory that stores the normative database described herein. The computer system may further comprise a graphical user interface for allowing users to interact with the normative database.

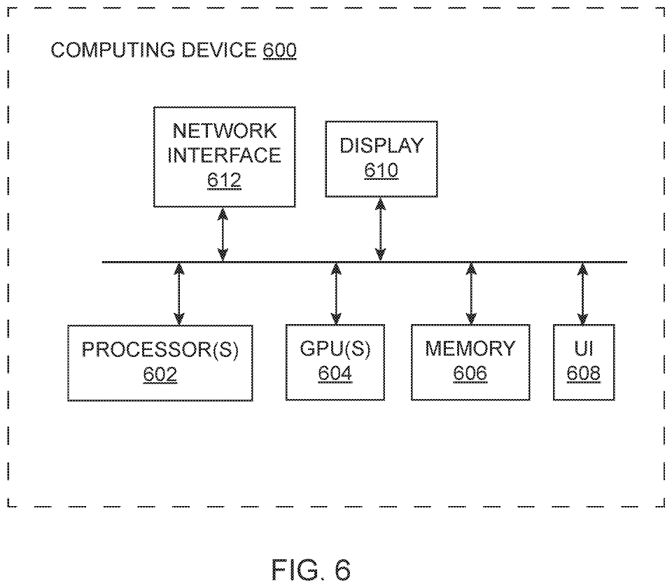

FIG. 6 depicts a block diagram illustrating one embodiment of a computing device that implements the methods and systems for generating an advertising-elasticity model using natural-language search described herein.

Referring to FIG. 6, the computing device 600 may include at least one processor 602, at least one graphical processing unit (“GPU”) 604, at least one memory 606, a user interface (“UI”) 608, a display 610, and a network interface 612. The memory 606 may be partially integrated with the processor(s) 602 and/or the GPU(s) 604. The UI 412 may include a keyboard and a mouse. The display 404 and the UI 412 may provide any of the GUIs in the embodiments of this disclosure.

As will be appreciated by one skilled in the art, aspects of the technology described herein may be embodied as a system, method or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the technology described herein may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technology described herein refer to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technology described herein. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description provided herein has been presented for purposes of illustration and description, but is not intended to be exhaustive or limited to the specific form disclosed. Many modifications and variations will be apparent to those of ordinary skill in the art without departing from the scope and spirit of the disclosure. The embodiment was chosen and described in order to best explain the principles described herein and the practical application of those principles, and to enable others of ordinary skill in the art to understand the technology for various embodiments with various modifications as are suited to the particular use contemplated.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-60. (canceled)

61. A system for determining an estimate of advertising elasticity using natural-language search, the system having at least one processor configured for:
receiving user-supplied natural-language search terms for querying a normative database,
wherein the normative database comprises normative data, the normative data including a mean value, a standard deviation value, and a plurality of existing tags for one or more advertising variables stored in the normative database;
deriving a mapping function based on the normative data by analyzing the plurality of existing tags in the normative data to determine a function that maps the plurality of existing tags to a set of normative topics associated with the normative data such that the set of normative topics represents variation in the plurality of existing tags across the normative database;
applying the derived mapping function to the user-supplied natural-language search terms,
wherein the user-supplied natural-language search terms are provided as inputs to the derived mapping function; and
generating a set of mapped user topics from the user-supplied natural-language search terms based on the derived mapping function;

62. The system of claim 61, wherein the at least one processor is further configured for:
running a regression model to infer a distribution of elasticity of the set of mapped user topics; and
deriving an estimate of advertising elasticity for the user-supplied natural-language search terms based on the regression model.

63. The system of claim 62, wherein running the regression model to infer a distribution of elasticity of the set of mapped user topics includes:
calculating the coefficient of variation for each record as the standard deviation divided by the mean;
running a series of quantile regression models with different percentile parameters to infer the quantile of the metric of interest based on mapped user topics;
estimating an array of quantiles associated with percentiles conditional on the mapped user topics; and
calculating the full distribution of the mean and coefficient of variation using the metalog distribution based on the quantiles and percentiles from the regression.

64. The system of claim 61, wherein the user-supplied natural-language search terms represent an advertising activity.

65. The system of claim 61, wherein the user-supplied natural-language search terms are received over a network.

66. The system of claim 61, wherein the user-supplied natural-language search terms are supplied by a user via a graphical user interface.

67. The system of claim 61, wherein the normative database comprises a relational database.

68. The system of claim 61, wherein the mapping function is derived by analyzing tags in the normative data using singular value decomposition.

69. The system of claim 61, wherein the mapping function is derived by analyzing tags in the normative data using non-negative matrix factorization.

70. The system of claim 61, wherein the mapping function is derived by analyzing tags in the normative data using latent Dirichlet analysis.

71. The system of claim 61, wherein synonyms of the user-supplied natural-language search terms are further provided as inputs to the derived mapping function.

72. The system of claim 71, wherein the synonyms of the user-supplied natural language search terms are determined using a synonym library.

73. The system of claim 61, wherein generating the set of mapped user topics from the user-supplied natural-language search terms is further based on a mapping between the existing tags and a set of meta-tags.

74. The system of claim 73, wherein the mapping between the existing tags and the set of meta-tags provides a mapping from a type of media to a communication modality.

75. The system of claim 73, wherein the mapping between the existing tags and the set of meta-tags provides a mapping from a type of media to a psychological appeal of the type of media.

76. The system of claim 61, wherein the set of mapped user topics corresponds to the set of normative topics associated with the normative data.

77. The system of claim 61, wherein the set of mapped user topics does not match the set of normative topics associated with the normative data.

78. The system of claim 62, wherein the estimate of advertising elasticity is calculated as a weighted average over a plurality of advertising variables in the normative database using the mean value and the standard deviation value for each of the plurality of advertising variables.

79. The system of claim 62, wherein the estimate of advertising elasticity is calculated by aggregating the plurality of mean values and standard deviation values.

80. The system of claim 62, wherein the estimate of advertising elasticity represents an advertising elasticity of an advertising activity based on the user-supplied natural-language search terms.
